(19) United States
(12) Patent Application Publication
(10) Pub. No.: US 2014/0157922 A1
(43) Pub. Date: Jun. 12, 2014

(54) ELECTRIC ASSIST STEERING SYSTEM

(71) Applicant: Dean Schneider, Washington, MI (US)

(72) Inventor: Dean Schneider, Washington, MI (US)

(21) Appl. No.: 13/711,059

(22) Filed: Dec. 11, 2012

(51) Int. Cl. F16H 25/20

(52) U.S. Cl. CPC F16H 25/20
USPC 74/89.34

(57) ABSTRACT

An electric assist steering system comprising a first lead screw connected to a steering shaft, a first lead screw nut engaged with the first lead screw, the first lead screw moveable along an axis of the first lead screw, a second lead screw, a second lead screw nut engaged with the second lead screw, the second lead screw connected to the first lead screw nut, an electric motor engaged with the second lead screw nut whereby the second lead screw nut is rotatable by the electric motor, and the first lead screw nut comprises a gear for engaging a steering system pinion.

### FIELD OF THE INVENTION

The invention relates to an electric assist steering system, and more particularly, an electric assist steering system having an electric motor coupled to a second lead screw for applying a force to a first lead screw nut.

### BACKGROUND OF THE INVENTION

Automotive power steering gears have been hydraulically assisted for many decades. Recent advancements in electronics coupled with the continued effort to save fuel have enabled the incorporation of electrically assisted steering systems into automobiles. These electrical assist devices focus on two areas primarily; rack assist and column assist. Rack assist systems focus on providing axial assist to the steering rack-and-pinion rack with an electrically driven lead screw and nut system. Column assist systems focus on providing torsional assist to the steering shaft prior to the steering mechanism with the mechanism (rack and pinion or steering gear) then using this increased input torque level to perform. What is needed is a means to provide electric assist within the steering gear itself.

Many steering gear systems use a lead screw and nut to transform the rotational motion of a steering wheel into linear motion. The linear motion is then used to move a gear linearly. The linear motion of the gear is then turned into rotational motion of the steering pitman shaft.

Hydraulic assist power steering gears hydraulically assist the linear motion of the gear and thus reduce the effort required from the driver of the vehicle.

Representative of the art is U.S. Pat. No. 8,312,959 which discloses a vehicle steering system transmission comprising a housing, an input shaft journalled to the housing, an electric motor connected to the housing and coupled to the input shaft, an output shaft journalled to the housing, the input shaft and the output shaft coupled by a first pair of sprockets having a first belt trained therebetween and having a first ratio, the first belt and first pair of sprockets comprising a helical tooth configuration, the input shaft and the output shaft coupled by a second pair of sprockets having a second belt trained therebetween and having a second ratio, and the input shaft and the output shaft coupled by a third pair of sprockets having a third belt trained therebetween and having a third ratio.

What is needed is an electric steering system having an electric motor coupled to a second lead screw for applying a force to a first lead screw nut. The present invention meets this need.

### SUMMARY OF THE INVENTION

An aspect of the invention is to provide an electric steering system having an electric motor coupled to a second lead screw for applying a force to a first lead screw nut.

Other aspects of the invention will be pointed out or made obvious by the following description of the invention and the accompanying drawings.

The invention comprises an electric assist steering system comprising a first lead screw connected to a steering shaft, a first lead screw nut engaged with the first lead screw, the first lead screw moveable along an axis of the first lead screw, a second lead screw, a second lead screw nut engaged with the second lead screw, the second lead screw connected to the first lead screw nut, an electric motor engaged with the second lead screw nut whereby the second lead screw nut is rotatable by the electric motor, and the first lead screw nut comprises a gear for engaging a steering system pinion.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a schematic of the prior art.

FIG. 2 is a schematic of the inventive system.

FIG. 3 is a perspective view of the exterior of the inventive system.

FIG. 4 is a perspective view of the interior of a portion of the inventive system.

FIG. 5 is a cross-sectional view of the inventive system.

FIG. 6 is a schematic of a steering system using the inventive system.

### DETAILED DESCRIPTION OF THE PREFERRED EMBODIMENT

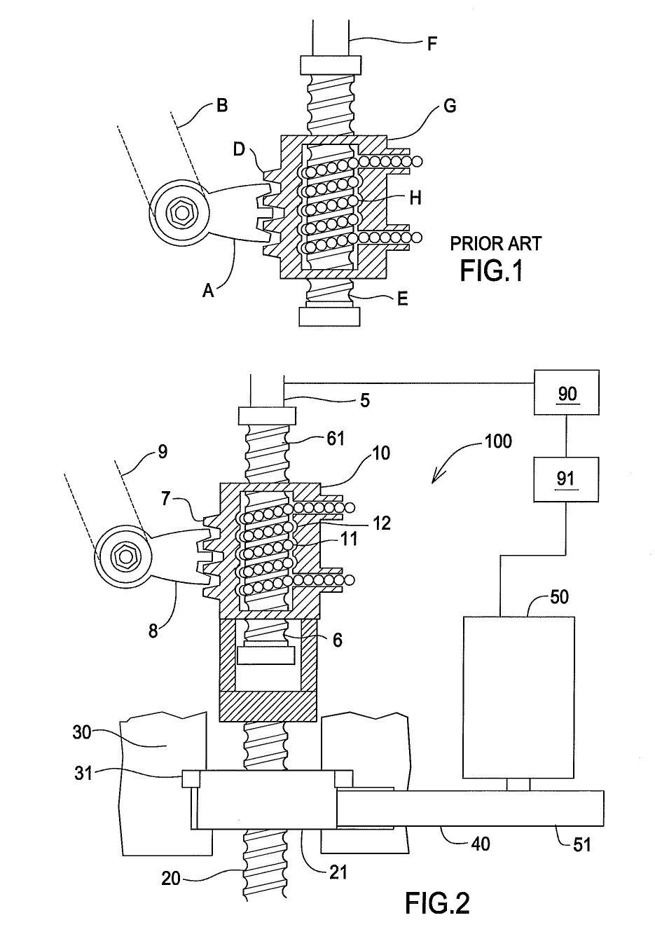

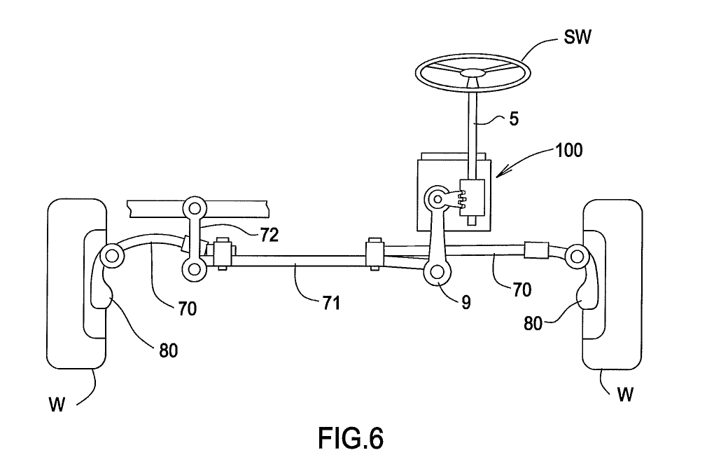

FIG. 1 is a schematic of the prior art. Prior art steering gear systems may comprise a steering gear box that contains a gear set. The gear set is a short rack and pinion system in which a pinion A is connected to a vehicle pitman arm B. The pitman arm B is connected to tie rods 70, see FIG. 6. The pitman arm B moves the tie rods which in turn rotate the steering knuckles which angularly move the wheels, thereby steering the vehicle.

Rack D moves in a linear manner along an axis of lead screw E. Lead screw E is directly connected to and is rotated by a steering shaft F. Rack D is formed on an outer surface of lead screw nut G. Movement of the lead screw nut G along lead screw E is facilitated by recirculating balls H, in a manner known in the art. A driver turns a steering wheel (not shown) which rotates steering shaft F which in turn rotates the lead screw E. This in turn moves the rack D linearly which rotates the pinion A and thereby pitman arm B.

FIG. 2 is a schematic of the inventive system. The inventive system 100 comprises a steering shaft 5 connected to a first lead screw 6. First lead screw 6 comprises a helical track 61 having a pitch. Rack 7 is disposed on an outer surface of lead screw nut 10. Lead screw nut 10 moves in a linear manner along an axis of first lead screw 6 upon rotation of steering shaft 5 and first lead screw 6.

Pinion 8 engages rack 7. Pinion 8 is connected to a pitman arm 9 as described for FIG. 1. Movement of lead screw nut 10 is facilitated by recirculating balls 11 engaging track 61. Lead screw nut 10 comprises a helical track 12 having a pitch on an inner surface of nut 10. Recirculating balls 11 are engaged between the track 61 and track 12.

The device 100 further comprises lead screw nut 10 fixedly attached to a second lead screw 20. The second lead screw 20 is threadably engaged with and rotationally coupled with a second lead screw nut 21. The second lead screw nut 21 is moveably fixed in the steering gear housing 30 but is free to rotate by use of a bearing 31.

The outer circumference of the lead screw nut 21 comprises a pulley or sprocket for engaging a flexible endless member 40. An electric motor 50 also comprises a pulley or sprocket 51 on the output shaft. A flexible endless member 40 is trained between sprocket 21 and sprocket 51. Flexible endless member 40 may comprise a toothed belt or a v-belt or a multi-ribbed v-belt or a chain.

When steering assist is needed, torque sensors 90 in the steering column sense a driver's input from the steering wheel and the need for assist. The torque signal is processed by a vehicle ECU 91 which activates the electric motor 50. Electric motor 50 turns the second lead screw nut 21 through member 40 which, in conjunction with its mating lead screw 20, transforms the rotational motion into linear force acting on the lead screw nut 10. The force provided by the lead screw 20 assists movement of the primary lead screw nut 10 thus reducing the driver's effort.

By way of example the following information is provided to illustrate an inventive system. The information is by example only and is not intended to limit the scope of the invention.

| Rack ratio | 1.96″:turn (50 mm:turn) |
|---|---|
| Belt drive ratio | 2.698:1 |
| >116 teeth large sprocket (number 21) | |
| >43 teeth small sprocket (number 51) | |
| Lead screw (6) pitch | 7 mm |
| Motor Torque (50) | 5 Nm |
| Motor turns to steering wheel turns 19:1 | |
| Mechanical advantage | |
| $\begin{matrix}MA = \frac{2 π}{l} η \\ l = lead \\ η = lead screw efficiency = 90 \% \\ \text{>} MA = \frac{2 π}{0.007} 0.9 = 807.8 / m\end{matrix}$ | |
| Torque into lead screw nut (21) | |
| T = Motor torque × Ratio | |
| T = 5 Nm (2.698) = 13.5 Nm | |
| Force applied to lead screw (20) | |
| F = Torque × MA | |
| F = 13.5 Nm × 807.8/m | |
| F = 10,905N (2450 Lbf) | |

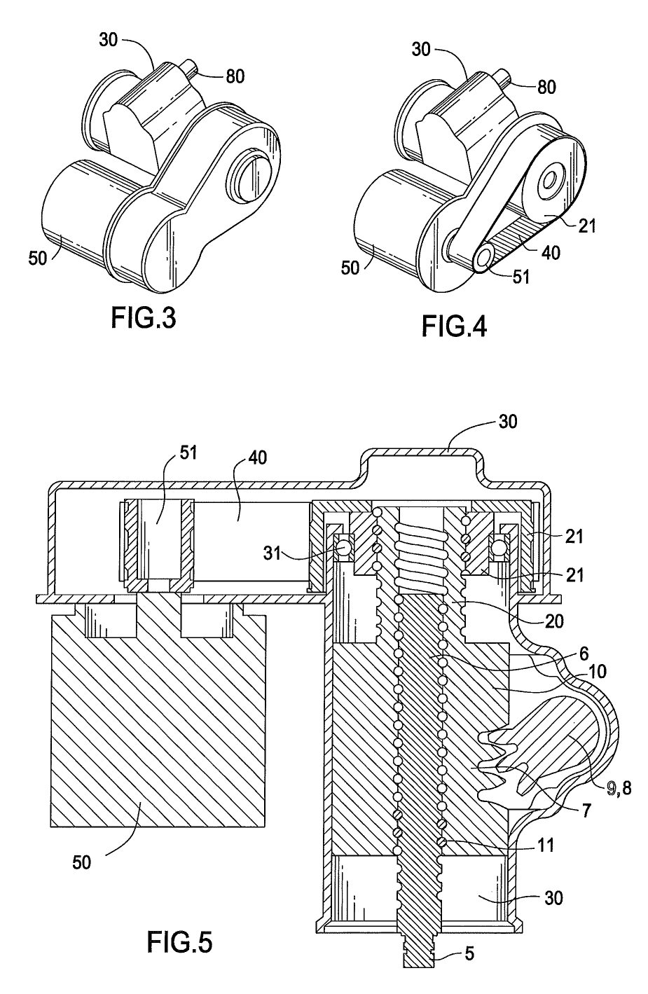

FIG. 3 is a perspective view of the exterior of the inventive system. Housing 30 encases the components described in FIG. 2. Pinion shaft 80 projects from housing 30.

FIG. 4 is a perspective view of the interior of a portion of the inventive system. Member 40 is trained between sprocket 21 and sprocket 51. Flexible endless member 40 may comprise either a toothed belt or a v-belt or a multi-ribbed belt, or a chain. If member 40 comprises a toothed belt, then sprocket 21 and sprocket 51 will each have a toothed surface to accommodate the belt. If member 40 is a multi-ribbed belt, then sprocket 21 and sprocket 51 will each have a multi-ribbed surface for engaging the belt. If member 40 is a v-belt then sprocket 21 and sprocket 51 will each have a single v profile. If member 40 comprises a chain then the system will include chain sprocket 21 and chain sprocket 51.

FIG. 5 is a cross-sectional view of the inventive system. Motor 50 comprises a 12V DC motor.

FIG. 6 is a schematic of a steering system using the inventive system. A steering wheel SW is connected to a steering shaft 5. Steering shaft 5 engages the electric assist steering system 100. Pitman arm 9 is connected to the inventive steering system 100. Pitman arm 9 is connected to a track rod 71. Tie rods 70 are connected to each end of the track rod 70. Each tie rod is connected to a steering arm 80. Each steering arm is connected in turn to a wheel W. Idler 72 is connected to the vehicle frame and is also connected to track rod 71 to preserve proper geometry for the system.

Although a form of the invention has been described herein, it will be obvious to those skilled in the art that variations may be made in the construction and relation of parts without departing from the spirit and scope of the invention described herein.

I claim:

1. An electric assist steering system comprising:
a first lead screw connected to a steering shaft;
a first lead screw nut engaged with the first lead screw, the first lead screw moveable along an axis of the first lead screw;
a second lead screw;
a second lead screw nut engaged with the second lead screw;
the second lead screw connected to the first lead screw nut;
an electric motor engaged with the second lead screw nut whereby the second lead screw nut is rotatable by the electric motor; and
the first lead screw nut comprises a gear for engaging a steering system pinion.

2. The system as in claim 1, wherein the electric motor is connected to the second lead screw nut with a belt.

3. The system as in claim 2, wherein the belt comprises a toothed surface.

4. The system as in claim 1, wherein the belt comprises a multi-ribbed surface.

5. The system as in claim 1 further comprising recirculating balls engaged between the first lead screw and the first lead screw nut.

6. An electric assist steering system comprising:
a first lead screw;
a first lead screw nut engaged with the first lead screw and moveable along an axis of the first lead screw;
a second lead screw;
a second lead screw nut engaged with the second lead screw;
the second lead screw connected to the first lead screw nut;
an electric motor engaged with the second lead screw nut by a flexible endless member whereby the second lead screw nut is rotatable by the electric motor; and
the first lead screw nut comprises a gear for engaging a pinion.

7. The system as in claim 6, wherein the flexible endless member comprises a belt.

8. The system as in claim 6, wherein the flexible endless member comprises a chain.

9. An electric assist steering system comprising:
a first lead screw;
a first lead screw nut engaged with the first lead screw;
a second lead screw;
a second lead screw nut engaged with the second lead screw;
the second lead screw fixedly connected to the first lead screw nut;
an electric motor drivingly engaged with the second lead screw nut whereby a rotation of the second lead screw nut advances the second lead screw; and
the first lead screw nut engagable with a pinion.

10. The system as in claim 9, wherein the electric motor is drivingly engaged with the second lead screw nut by a flexible endless member.

11. The system as in claim 10, wherein the flexible endless member comprises a belt.

12. The system as in claim 9 further comprising a plurality of spherical members disposed in a track between the first lead screw and the first lead screw nut.

13. The system as in claim 12 further comprising a plurality of spherical members disposed in a track between the second lead screw and the second lead screw nut.

14. The system as in claim 11, wherein the belt comprises a toothed belt.

15. The system as in claim 10, wherein the flexible endless member comprises a chain.
